(19) United States
(12) Patent Application Publication
(10) Pub. No.: US 2007/0142159 A1
(43) Pub. Date: Jun. 21, 2007

(54) Zero clearance hinge mounting for an adjustment apparatus of a motor vehicle seat

(75) Inventor: Hubert Biehler, Kassel (DE)

Correspondence Address: MCCARTER & ENGLISH LLP;CITYPLACE I, 185 ASYLUM STREET, HARTFORD, CT, 06103, US

(73) Assignee: C. Rob. Hammerstein GmbH & Co. KG

(21) Appl. No.: 11/643,065

(22) Filed: Dec. 20, 2006

(30) Foreign Application Priority Data
Dec. 20, 2005 (DE) 10 2005 061 314.4
Oct. 5, 2006 (DE) 10 2006 047 061.3

(51) Int. Cl. F16H 57/08

(52) U.S. Cl. 475/331

(57) ABSTRACT

The hinge mounting for an adjustment apparatus of a motor vehicle seat has a first outer wheel with an inner toothed surface and a second outer wheel with an inner toothed surface. At least two planet wheels mesh with both the first inner toothed surface and the second inner toothed surface. A driving toothed sun wheel meshes with the planet wheels. The sun wheel has a first gear wheel and a second gear wheel that are disposed axially behind each other; either gear wheel meshes with the planet wheels. The two gear wheels have coinciding toothed surfaces. The first gear wheel has a first out-of-round that has at least one first flank. The second gear wheel has a second out-of-round that has at least one second flank. In a state in which the toothed surfaces of the two gear wheels are aligned, the flanks are not aligned. An elastic element rests against the flanks and exerts an elastic bias between the first flank and the diametrically opposed second flank.

### CROSS REFERENCE TO RELATED APPLICATIONS

This application claims priority to German Application No. DE 10 2005 061 314.4, filed Dec. 20, 2005, and German Application No. DE 10 2006 047 061.3, filed Oct. 5, 2006, the contents of which are expressly incorporated by reference in their entirety as part of the present disclosure.

### BACKGROUND

The invention relates to a zero clearance hinge mounting for an adjustment apparatus of a motor vehicle seat. The hinge mounting has a first outer wheel having a first inner toothed surface and a second outer wheel having a second inner toothed surface, with the two outer wheels being adjustable relative to each other about a hinge axis. The hinge mounting further has at least two planet wheels that are meshing both with the first outer wheel and with the second outer wheel and that are disposed each for rotation about a planet wheel axis. Finally, the hinge mounting has a driving, toothed sun wheel that meshes with the at least two planet wheels.

Numerous such type hinge mountings have been previously proposed and notoriously used, they are previously known from U.S. Pat. No. 5,183,447, DE 3201309 C2 and DE 103 27 090 A1 for example.

In such type hinge mountings, precise meshing of at least one of the planet wheels with the two inner toothed surfaces of the external gear wheels is necessary for providing hinge mountings with zero clearance. Such a hinge mounting being typically used for the reclining angle adjustment of a seat back of a motor vehicle seat and the seat back constituting a quite long lever arm, the hinge mounting must be provided with sufficient little clearance to prevent perceivable play from occurring at the upper edge of the seat back.

This is where the invention comes to bear. It is an object of the invention to further develop the hinge mounting of the type mentioned herein above so that the two outer wheels are retained by at least one of the planet wheels with zero clearance, at any rate with the least possible clearance so that the hinge mounting be provided with a zero clearance fit.

### SUMMARY

In view of the hinge mounting of the type mentioned herein above, this object is solved in that the sun wheel has a first gear wheel and a second gear wheel, that these two gear wheels are disposed axially behind each other, that each of the two gear wheels meshes with the planet wheels, that these two gear wheels have coinciding toothed surfaces, that the first gear wheel has a first out-of-round, central recess (40) that has at least one first flank, that the second gear wheel has a second out-of-round central recess having at least one second flank, that, in a state where the toothed surfaces of the two gear wheels are aligned, the flanks are not aligned and that there is provided an elastic element that rests against the flanks and exerts an elastic bias between the first flank and the diametrically opposed second flank.

The sun wheel is composed of two gear wheels of preferably the same thickness, both gear wheels may perform by themselves the function of the sun wheel, they only differ from the prior art sun wheel by their reduced thickness. The recesses of the two gear wheels are rotated with respect to each other. The elastic element strives to accommodate this rotation. If the rotation of the two recesses is accommodated, the teeth of the two gear wheels are offset relative to each other. As a result, they act like wide teeth and are thus capable of compensating the clearance. In practical operation, the elastic element is constantly active and causes the teeth of a respective one of the two gear wheels to rotate until the clearance is compensated for. It is understood that the maximum spread obtained when the two recesses are aligned will not be achieved in practical operation. The size of this maximum spread has rather been chosen so as not to be needed in practical operation.

The elastic element is either part of a drive shaft or the drive shaft extends therethrough. The elastic element is disposed in the center inside the recesses and directly effects a torque. This is an advantage over off-center arrangements that need in most cases more than one spring element.

The invention makes very small sun wheels possible. Through the additional elastic element, the sun wheel is hardly greater than a prior art one, without clearance compensation. The elastic element hardly occupies more space than needed for the driving shaft anyway. The rotatable hinge mounting of the invention is also easy to assemble since the elastic element may be mounted mechanically. Mounting may for example occur by plug-type mounting or by compressing the elastic element so that the latter adopts a mounted condition.

In a preferred developed implementation, the two gear wheels of the sun wheel may be built according to the same principle. For mounting, however, it is then necessary to turn the one gear wheel by 180° with respect to the other. In this embodiment, the recess is rotated by half the offset that will later be provided in the assembled hinge mounting.

The elastic element acts onto the flanks of the recesses. The recesses are arranged in such a manner that the flanks on which the elastic element abuts are diametrically opposed. In this way, a torque is only effected by the elastic element. Although the elastic element could also very possibly effect slight displacements of the two gear wheels forming the sun wheel relative to each other in the radial plane, it is in any case intended to effect the relative rotation of the two gear wheels.

It has been found that recesses in the form of a regular polygon with quite a few angles, more specifically a triangle and a rectangle, are particularly preferred. A quite elongated rectangle is for example favourable. Due to the geometrical circumstances, the lever arms are then big so that quite high torques are achieved.

### BRIEF DESCRIPTION OF THE DRAWINGS

Other features and advantages will become more apparent upon reviewing the appended claims and the following non restrictive description of embodiments of the invention, given by way of example only with reference to the drawing. In the drawing:

FIG. 1: is a perspective illustration of a seat back with two hinge mountings, a drive shaft and two different drives;

FIG. 2: is an exploded view of a hinge mounting corresponding to FIG. 1, but without an elastic element, and of an elastic element that is located thereabove and is part of a drive shaft;

FIG. 3: is a top view of the two gear wheels forming the sun wheel, with the teeth being aligned;

FIG. 4: is a top view like FIG. 3, but now with the recesses being aligned;

FIG. 5: is an axial sectional view through the two gear wheels with an elastic element according to FIG. 2 at the moment of mounting;

FIG. 6: is the illustration according to FIG. 5, but now in the mounted condition,

FIG. 7: is the top view of a hinge mounting similar to the one in the previous figures, but with another geometrical shape;

FIG. 8: is a perspective view of an elastic element having a tubular shape and as a square;

FIG. 9: is a top view of two gear wheels with offset teeth and aligned recesses in the shape of squares;

FIG. 10: is a perspective illustration of another embodiment of an elastic element for square recesses;

FIG. 11: is a sectional view similar to FIG. 5, but now with a barrel-shaped elastic element in a square configuration and for square recesses;

FIG. 12: is an illustration similar to FIG. 11, but now in the mounted condition;

FIG. 13: is a perspective illustration of a mounting tool with an elastic element mounted therein similar to FIG. 12 and with a hinge mounting located underneath; and

FIG. 14: is a perspective illustration of a sun wheel, consisting of two gear wheels and four springs, but not according to the wording of patent claim 1.

### DETAILED DESCRIPTION

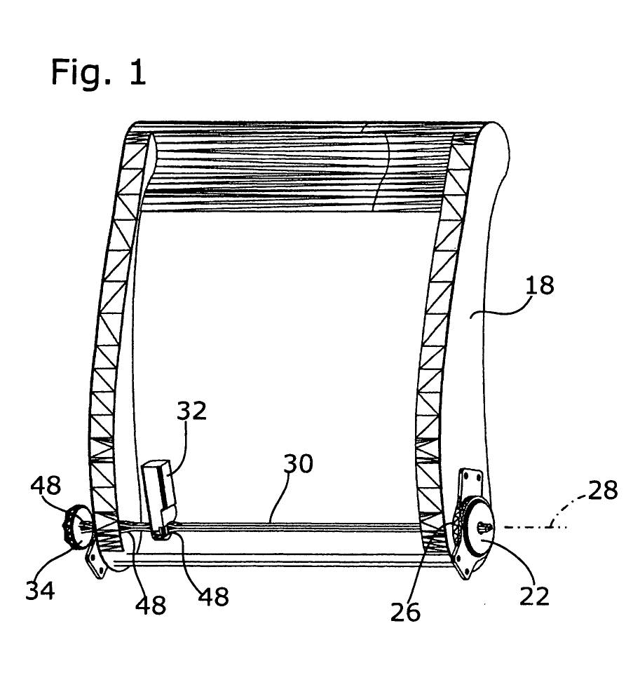

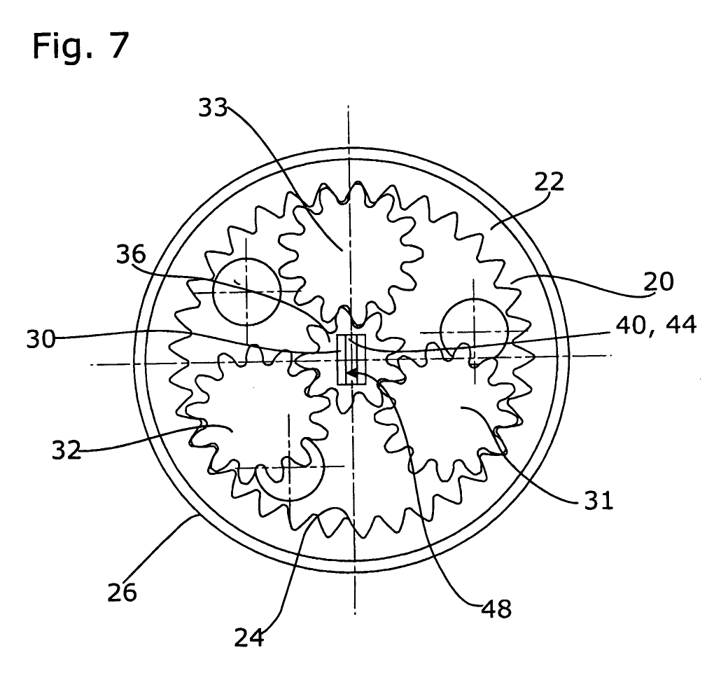

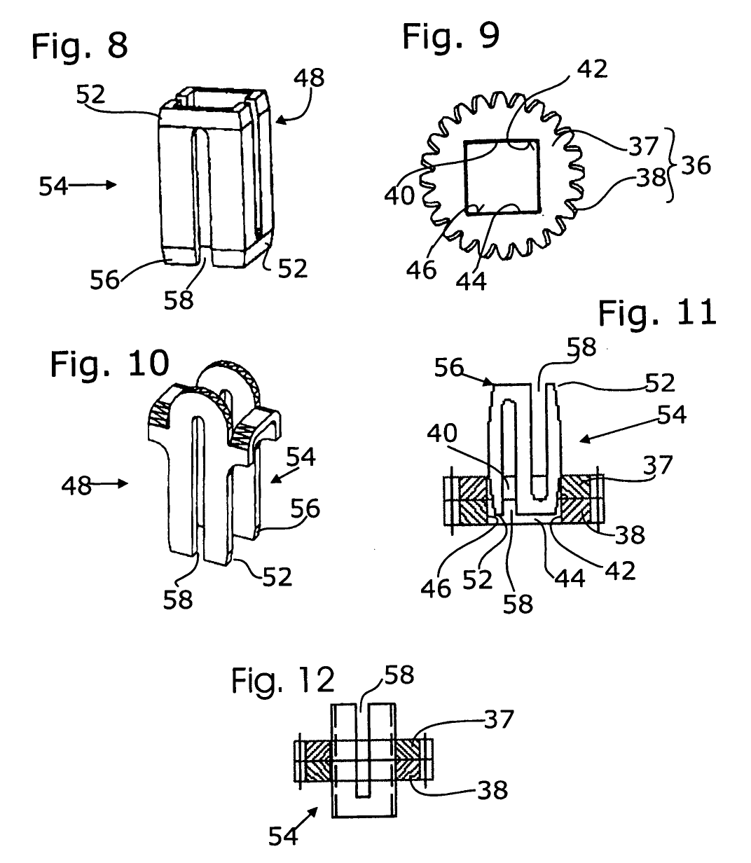

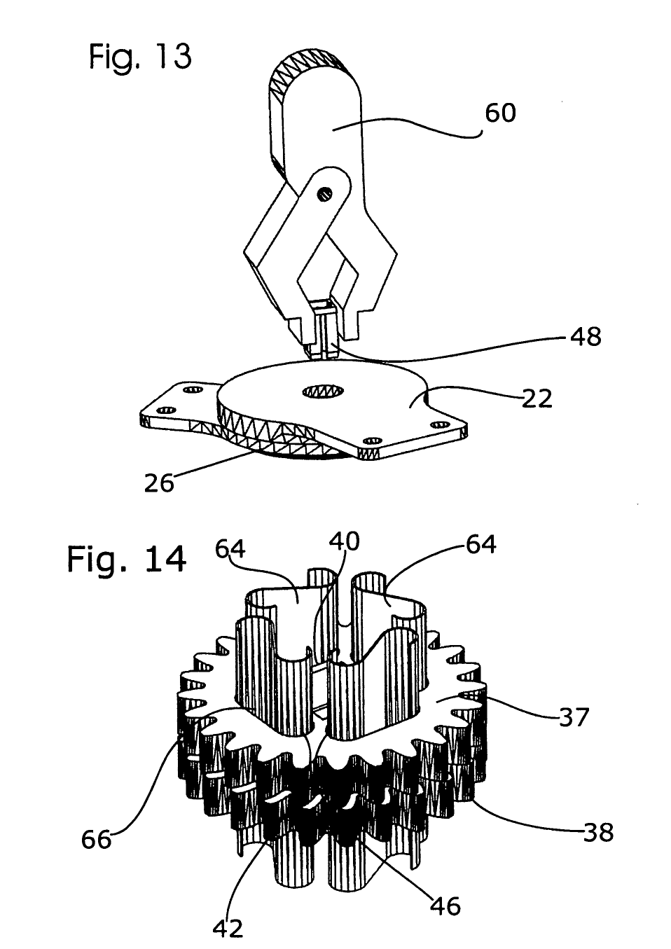

The FIGS. 1 through 6 relate to a first exemplary embodiment, FIG. 7 shows a second exemplary embodiment that is however strongly akin to the first exemplary embodiment. The FIGS. 8 and 9 show a third exemplary embodiment. A fourth and a fifth exemplary embodiment are shown in FIG. 10 and in FIG. 11. The FIGS. 12 and 13 show a sixth exemplary embodiment. FIG. 14 finally shows a seventh exemplary embodiment.

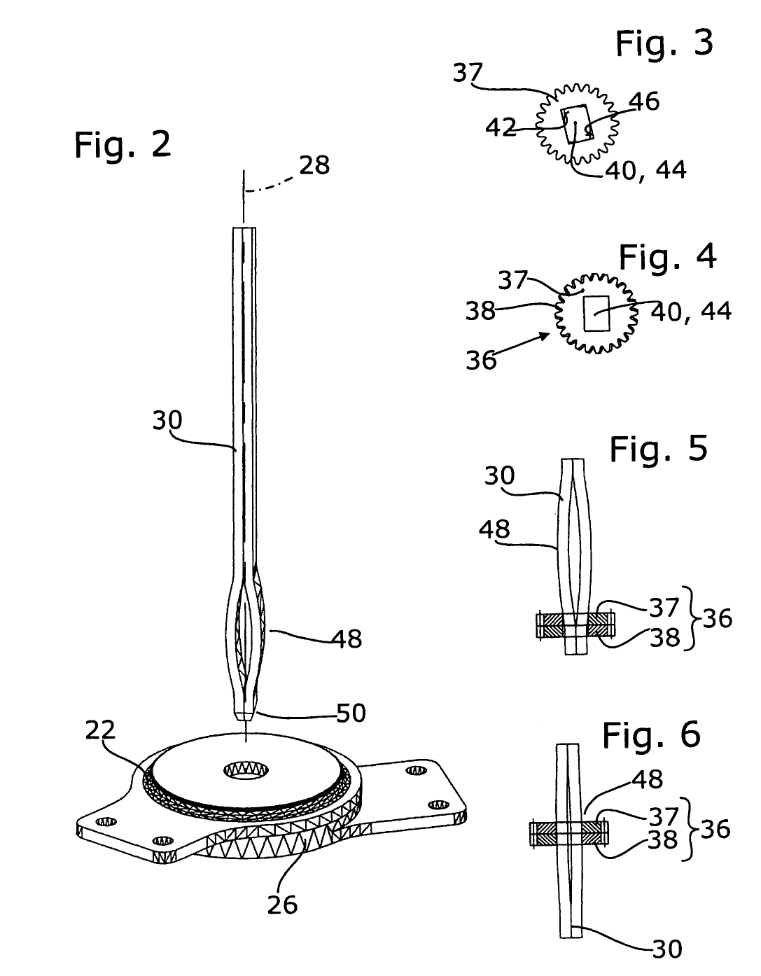

FIG. 1 shows a seat back 18 with two hinge mountings. These are built according to the same principle and are implemented as can be seen in the FIGS. 2 through 6 for the first exemplary embodiment. In a known manner, each hinge mounting has a first outer wheel 22 provided with a first inner toothed surface 20 and a second outer wheel 26 provided with a second inner toothed surface 24. The two outer wheels 22, 26 are relatively rotatable and adjustable about a hinge axis 28.

The in all three planet wheels 31, 32, 33 mesh with the two toothed outer wheels 22, 26 (FIG. 7). Meshing occurs both with the first outer wheel 22 and with the second outer wheel 26. The planet wheels 31-33 are built according to the same principle. The outer wheels 22, 26 differ in the total number of teeth of their inner toothed surfaces 20, 24, in the concrete exemplary embodiment, they differ by three teeth. The planet wheels 31-33 mesh with a sun wheel 36; it is driven by means of a drive shaft 30 with the hinge axis 28 as the axis. For passage of the drive shaft 30, bores are provided in the outer wheels 22, 26. The drive shaft 30 is driven, for example by a motor 32 and/or a handgrip 34, as shown in FIG. 1.

For reasons of simplification, FIG. 7 does not show in detail the differing number of teeth of the two outer wheels 22, 26; this number is known in principle and needs not be represented separately.

Each planet wheel 31-33 has a free planet wheel axis about which it rotates, when an adjusting movement is carried out. There may be provided a guide part that forms bearing openings for journals of the planet wheels 31-33. In principle, it is not necessary to have a planet wheel 31-33 carried on bearings.

The sun wheel 36 has a toothed surface that meshes with the planet wheels 31 through 33. The sun wheel 36 is composed of two gear wheels, namely a first gear wheel 36 and a second gear wheel 38. These are placed close on top of each other and are capable of rotating relative to each other. They are disposed axially behind each other. Each of the two gear wheels 36, 38 meshes with the planet wheels 31 through 33. The two gear wheels 36, 38 have a coinciding toothed surface, in the concrete exemplary embodiment they are built according to the same principle. The first gear wheel 36 has a non round, central first recess 40 that has at least one first flank 42. The second gear wheel 38 has a second recess 44 of the same shape that has at least one second flank 46. The flanks 42, 46 are diametrically opposed.

In the assembled condition of the two gear wheels 36, 38 according to FIG. 3, the teeth are aligned, the two recesses 40, 44 are rotated relative to each other by an angle. In the illustration according to FIG. 4, the two recesses 40, 44 are aligned but not the teeth, it is clearly seen that the teeth are now wider than in the configuration according to FIG. 3. Clearance is compensated for by the wider teeth. For this purpose, an elastic element 48 is provided, which is preferably configured to be a metal spring. Further, different metal springs are presented in the form of spring bodies. In principle however, the elastic element 48 may also be manufactured from another material, for example from an elastomer.

In the first and in the second exemplary embodiment, the recesses 40, 44 are elongated rectangles. The elastic element 48 is formed from two outwardly curved leaf springs; they are an integral part of the drive shaft 30. The drive shaft is formed from two elongated sheet metal strips that belly outwardly at the points where the elastic element 48 is provided for. The drive shaft according to FIG. 1 has three elastic elements 48. It is preferred to use a spring steel. The width of the strips is adapted to the large dimension of the rectangle of the recesses 40, 44. The smaller side of the rectangle is slightly longer than the double width of the strips, see e.g. FIG. 6. As a result, between the strips there remains an air gap that can be seen e.g., in FIG. 6. The strips abut the flanks 42, 46 under the action of the spring, trying to urge these into the position according to FIG. 4. The complete position shown in FIG. 4 is not reached in the assembled condition of the hinge mounting though; an intermediate position is achieved instead, which moreover varies depending on the relative position of each part of the toothed surfaces.

Mounting will now be explained, referring to the FIGS. 2, 5 and 6. As can be seen from FIG. 2, an insertion end 50 or a somehow tapering portion is provided for at the lower free end of the drive shaft 30. This portion is dimensioned so that the insertion end 50 may even be inserted into the recesses 40, 44 in the condition shown in FIG. 3. Due to the inclined portions of the insertion end 50, the recesses 40, 44 are given a first orientation when the drive shaft 30 is urged from the top into the hinge mounting, meaning into the recesses 40, 44, as shown in FIG. 2. Then, the condition shown in FIG. 5 is achieved at first. As the drive shaft 30 is further pushed in, the condition shown in FIG. 6 is achieved. This is the mounted, final condition.

The second exemplary embodiment of FIG. 7 shows how small the sun wheel 36 may be configured. It may have an outer diameter of less than 40%, preferably of less than 35%, more preferably smaller than 30% of the inner diameter of the internal toothed surfaces 20, 24. In FIG. 7, the outer diameter of the sun wheel is about 80% of the outer diameter of the planet wheels 31-33. The second exemplary embodiment may also be realized with one of the elastic elements 48 that can be seen from the other exemplary embodiments.

The third exemplary embodiment shown in the FIGS. 8 and 9 shows a tubular elastic element having a square shape. A square recess 40, 44 as it can be seen from FIG. 9 belongs thereto. FIG. 9 shows the condition like in FIG. 4, meaning with a maximum offset of the teeth of the two gear wheels 36, 38 and the alignment of the recesses 40, 44.

As can be seen from FIG. 8, the elastic element 48 has an insertion portion 52 on either side and a spring portion 54 in its center. For practical use, one insertion portion 52 provided on one end would be enough. The insertion portion 52 has wedged inclines 56. The insertion portion 52 serves the same purpose as the insertion portion 50 of the drive shaft 30, meaning it allows for insertion into the recesses 40, 44, even if the teeth of the gear wheels 36, 38 are aligned. A pressure then causes the spring region 54 to be urged into the region of the recesses 40, 44 during mounting. If the spring region 54 abuts the flanks 42, 46 of the recesses 40, 44, the mounting is completed.

It can be seen that the insertion portion 52, like the insertion end 50, has a cross section that is determined in the radial plane and is smaller than the free passage defined by the two recesses 40, 44, when the gear wheels have their teeth aligned.

The elastic element 48 shown in FIG. 8 has longitudinal non-through slots 58; such a longitudinal slot is provided in the center of either of the four walls. These are thereby offset, two longitudinal slots taking departure from the one direction, namely from the top, whilst two longitudinal slots take departure from the bottom.

FIG. 10 shows another configuration of the elastic element 48; it may replace the elastic element 48 shown in FIG. 8. It has four downwardly directed spring legs that belong to substantially U-shaped springs that are connected at the top through two lateral bridges. The elastic element 48 shown in FIG. 10 may be manufactured from a flat, bent stamping. The exemplary embodiment shown in FIG. 10 only has an insertion portion 52 at its lower end. The upper portion, by contrast, is prevented by the bridges from entering the recesses 40, 44.

FIG. 11 shows another exemplary embodiment of the elastic element 48, this time the spring portion does not have a constant thickness; starting from the insertion portion 52, which is again provided on either end, the thickness increases instead to form a convex shape, reaching its maximum in the longitudinal center. The elastic element 48 again has longitudinal slots 58, this time two for each wall, meaning eight in all. These are also offset relative to each other. FIG. 11 shows the moment in which the elastic element is being inserted 48 into a sun wheel 36, the elastic element 48 is already partially inserted. It can be seen that the axial length of the elastic element 48 is greater than the overall thickness of the sun wheel 36. This also applies for the other embodiments.

The embodiment shown in the FIGS. 12 and 13 approximately corresponds to the configuration shown in FIG. 8, except that here there is provided no insertion portion 52 because mounting occurs with the help of a tool 60 as it is illustrated in FIG. 13. This tool is implemented like tongs. With the help of the tool 60, the elastic element 48 is elastically deformed to such an extent that it may be inserted into the recesses 40, 44, even if the teeth of the gear wheels 36, 38 are aligned. It is preferred that the tool 60 also has second tongs that are offset 90° about the longitudinal axis 28 and that actuate the walls of the tubular elastic element 48 that have not yet been touched in FIG. 13, urging them towards each other. As can be seen from FIG. 13, there may also be used a combination, meaning certain inclined portions at the free end for facilitating insertion together with the utilization of the tool 60.

As can be seen from the exemplary embodiments, the elastic element 48 has a central opening 62 through which a drive shaft that has not been illustrated in closer detail herein can be passed. Preferably, projections protrude from the inner surface area of this central opening 62 and interlock with the drive shaft 30 as the drive shaft is being introduced, thus providing for a zero clearance registration fit.

The exemplary embodiment shown in FIG. 15 shows no central elastic element, but four off-center elastic elements 64 instead. They are made from a flat spring steel sheet blank and curved into an S shape. They are accommodated in long holes 66 that are evenly distributed about the hinge axis 28 and are provided spaced apart from the recesses 40, 44. Like the recesses 40, 44, the long holes 66 of the two gear wheels 37, 38 are also offset and also have flanks 42, 46. They prevent the toothed surfaces from being aligned. This is also shown in FIG. 14.

The recesses 40, 44 are now no longer needed for utilizing an elastic element. Now, only one of the recesses, for example the one of the upper gear wheel 36, precisely fits the drive shaft 30, the other one has sufficient play not to hinder the rotation of the other gear wheel with respect to the drive shaft 30.

What is claimed is:

1. A hinge mounting for an adjustment apparatus of a motor vehicle seat comprising:
a first outer wheel defining a first inner toothed surface;
a second, concentric outer wheel defining a second inner toothed surface and is rotatable and adjustable about a hinge axis relative to the first outer wheel;
at least two planet wheels that mesh with both the first inner toothed surface and the second inner toothed surface and are arranged to freely rotate;
a driving sun wheel defining a toothed surface and meshes with the at least two planet wheels, wherein the sun wheel has a first gear wheel and a second gear wheel, the first and second gear wheels each define coinciding toothed surfaces and are disposed axially behind each other and mesh with the planet wheels, the first gear wheel has a first out-of-round that has at least one first flank, the second gear wheel has a second out-of-round having at least one second flank, that, in a state wherein the toothed surfaces of the two gear wheels are aligned, the first flank and the second flank are not aligned; and
an elastic element that rests against the first flank and the second flank and exerts an elastic bias between the first flank and the diametrically opposed second flank.

2. The hinge mounting as set forth in claim 1, wherein the two gear wheels of the sun wheel are manufactured as like parts and according to the same principle.

3. The hinge mounting as set forth in claim 1, further comprising a drive shaft that drives the sun wheel, wherein the elastic element has a central opening and that the drive shaft passes through the central opening.

4. The hinge mounting as set forth in claim 1, further comprising a drive shaft that drives the sun wheel, wherein the elastic element is a part of the drive shaft.

5. The hinge mounting as set forth in claim 1, wherein the elastic element is substantially tubular.

6. The hinge mounting as set forth in claim 1, wherein the elastic element has longitudinal slots.

7. The hinge mounting as set forth in claim 1, wherein the elastic element has an axial length that is greater than the sum of the thicknesses of the two gear wheels of the sun wheel.

8. The hinge mounting as set forth in claim 7, wherein the elastic element comprises an insertion portion and a spring portion that are disposed axially behind each other, wherein the insertion portion is formed on an axial end of the elastic element and the insertion portion has a radial cross section that is smaller than the free passage defined by the two recesses when the gear wheels are rotated with respect to each other in such a manner that the toothed surfaces of the two gear wheels are aligned.

9. The hinge mounting as set forth in claim 8, wherein the insertion portion comprises wedged inclines.

10. The hinge mounting as set forth in claim 1, wherein the elastic element is elastically deformable between a mounting condition and a normal condition and that, in the mounted condition, the elastic element has a radial cross section that is smaller than the free passage defined by the two recesses when the gear wheels are rotated with respect to each other in such a manner that the toothed surfaces of the two gear wheels are aligned.

11. The hinge mounting as set forth in claim 10, further comprising a tool for assisting in reducing the size of the elastic element to its mounting condition.

12. The hinge mounting as set forth in claim 1, wherein the two recesses have the same shape.

13. The hinge mounting as set forth in claim 1, wherein, in the condition in which the toothed surfaces of the two gear wheels are aligned, the first recess is rotated an angle with respect to the second recess.

14. The hinge mounting as set forth in claim 1, wherein the two recesses each define a center lying on the hinge axis.

15. The hinge mounting as set forth in claim 1, wherein the two recesses have the shape of one of a quadrangle, a square and a triangle.

16. The hinge mounting as set forth in claim 1, wherein one gear wheel is mounted in a first position within the hinge mounting and the other gear wheel is mounted in a second position that is flipped 180 degrees with respect to the first position.

17. The hinge mounting as set forth in claim 1, wherein, in the condition in which the toothed surfaces of the two gear wheels are aligned, the first recess is rotated an angle with respect to the second recess and that the angle is smaller than 360/2n degrees, with the number of teeth of each gear wheel being n.

18. The hinge mounting as set forth in claim 1, wherein, in the condition in which the toothed surfaces of the two gear wheels are aligned, the first recess is rotated an angle with respect to the second recess and that the angle is smaller than 10 degrees.

19. The hinge mounting as set forth in claim 1, wherein, in the condition in which the toothed surfaces of the two gear wheels are aligned, the first recess is rotated an angle with respect to the second recess and that the angle is smaller than 5 degrees.
